(19) United States
(12) Patent Application Publication
(10) Pub. No.: US 2023/0042374 A1
(43) Pub. Date: Feb. 9, 2023

(54) COOKING SYSTEM

(71) Applicant: Wildbrand Products, LLC, Boone, NC (US)

(72) Inventors: Scott Kobryn, Boone, NC (US); Ryan Vick, Zionville, NC (US)

(73) Assignee: Wildbrand Products, LLC, Boone, NC (US)

(21) Appl. No.: 17/817,532

(22) Filed: Aug. 4, 2022

Related U.S. Application Data
(60) Provisional application No. 63/229,093, filed on Aug. 4, 2021.

(51) Int. Cl. A47J 37/07

(52) U.S. Cl. CPC A47J 37/0704; A47J 37/0786

(57) ABSTRACT

A cooking system including a housing assembly provided with lid, which define a plurality of cooking zones and a thermal energy zone. One of the cooking zones is located beneath the thermal energy zone to utilize convection thermal energy transfer and radiant thermal energy transfer during operation of the cooking system. A blower assembly of the cooking system forces a fluid through at least one fluid flow path of the housing assembly and the thermal energy zone, to provide a superheated fluid having a temperature of about 800° F. to about 1200° F. to at least one of the cooking zones.

### CROSS-REFERENCE TO RELATED APPLICATION

This application claims the benefit of U.S. Provisional Patent Application Ser. No. 63/229,093, filed Aug. 4, 2021, the entirety of which is herein incorporated by reference.

### FIELD

The disclosure relates to a cooking system, and more particularly to a multi-function cooking system.

### BACKGROUND

Outdoor grills and cooking appliances are used for the preparation of food utilizing solid fuel (charcoal or wood) or gaseous fuel sources.

Maximum temperature achievable for gas-fueled outdoor grilling products is typically 550° F. and materials of construction vary between ferrous and nonferrous metals such as stainless steel. Higher temperature searing appliances exist that utilize an infrared spectrum of heat generated from the gas burner. Gas fueled outdoor grilling products have adjustable temperatures in whole or by zone and have burners located below the grill or cooking surface.

Solid fuel sources such as charcoal burn at a maximum temperature of 2000° F. in atmospheric conditions and 2300° F. if supplied with excess air.

Maximum temperature achievable for solid fueled (charcoal) outdoor grilling products is typically 700° F. and materials of construction vary between ferrous and nonferrous metals such as stainless steel as well as ceramic and refractory materials. Elevated temperatures are reached through increased convection air flow up through the solid fuel bed which is located below the grill or cooking surface.

High-temperature (800° F.-1200° F.) searing and cooking of foods creates desirable results found in restaurants. In a professional kitchen, chefs use specialized cooking devices such as salamander broilers to reach high temperatures for searing, broiling and cooking foods. In the market today, only specialized commercial cooking devices are capable of reaching 800° F.-1200° F. and are impractical for home use in terms of cost, service and space requirements.

Further, conventional grilling arrangements generally are not able to provide a multi-functional approach to barbecue cooking. Such systems generally are specialized in their nature, and are incapable of performing multiple levels of barbecue grilling.

There is a need for an arrangement that employs conventional charcoal fuel and which can effect barbecue-style cooking in conventional and searing modes of operation.

Therefore, it would be desirable to provide a cooking system that is multi-functional and can advantageously be employed in conventional barbecue, cooking, and searing modes of operation.

### SUMMARY

In concordance and agreement with the presently described subject matter, a cooking system that is multi-functional and can advantageously be employed in conventional barbecue, cooking, and searing modes of operation, wherein a weight, a cost, and complexity thereof is minimized, has surprisingly been discovered.

High-temperature (800° F.-1200 F) searing and cooking of foods creates desirable results found in restaurants. In a professional kitchen chefs use specialized cooking devices such as salamander broilers to reach high temperatures for searing, broiling and cooking foods.

Home-based cooking enthusiasts desire the same professional high-temperature results but traditional gas or solid fuel cooking products cannot reach 800° F.-1200° F. temperatures.

The presently disclosed subject matter is an outdoor broiling, searing and grilling device with four separate cooking zones consisting of a high-temperature broiler-oven, a traditional grill, an elevated and rotating grill, and a warming center. The round metal body of the cooking system contains a thermal energy source that sits on a screened surface located above the broiler-oven and a traditional grill which is located above the thermal energy source. The lid of the cooking system is designed to hold a 12″ cooking device for food warming and cooking utilizing the convection waste heat rising above the cooking system. The elevated and rotating grill rack attaches to an exterior of the device and is adjustable up and down, as well as rotatable away from the thermal energy source.

To create optimal broiling or searing temperatures of 800° F.-1200° F. in the broiler-oven, an adjustable blower assembly, provided with the cooking system, pushes pressurized air into the grill area. With the lid closed, the natural upward convection air flow is reversed and air is forced downward through the thermal energy source, which sits on the screen member. The screen member allows downward flow of superheated air utilized for high-temperature cooking. The superheated air then passes through the screen member into the broiler-oven creating optimal broiling and searing temperatures of 800° F.-1200° F. Utilizing the adjustable air blower assembly also creates balanced, sustainable high-temperature conditions for long periods of time. In traditional barbeque grilling, rising convection air upward through the thermal energy source is adjustable, by manual damper, to accommodate all styles of traditional barbeque cooking and grilling. A user of the presently disclosed subject matter benefits from the flexibility of uses to prepare a wider variety of foods at varying temperatures with desirable results at each temperature range and cooking zone. The user will furthermore benefit from reduced time it takes for the presently disclosed subject matter to reach desired high temperatures as well as the ability to transition quickly to different temperatures and cooking zones based on the desired cooking method during operation of the cooking system. The user will also benefit from consistent, stable cooking conditions over longer periods of time due to the powered airflow and damper adjustments.

In one embodiment, a cooking system, comprises: a housing assembly having a plurality of cooking zones and at least one thermal energy zone provided therein, wherein the at least one thermal energy zone is located between a pair of the cooking zones.

In some embodiments, the cooking zones generate temperatures in range of about 200° F. to about 1200° F.

In some embodiments, at least one of the cooking zones generates a temperate of at least 1100° F.

In some embodiments, at least one of cooking zones of the cooking system utilizes convection thermal energy transfer and radiant thermal energy transfer.

In some embodiments, the at least one thermal energy zone is provided with a thermal energy source and a thermal energy assembly configured to contain the thermal energy source therein.

In some embodiments, the housing assembly provides four cooking zones.

In another embodiment, a cooking system, comprises: a housing assembly having at least one cooking zone; and a thermal energy assembly disposed within the housing assembly, wherein the thermal energy assembly is configured to permit a flow of a fluid therethrough while militating against particulate material entering the at least one cooking zone.

In some embodiments, the housing assembly includes an inner housing structure and an outer housing structure.

In some embodiments, at least a portion of the inner housing structure is formed from a cast aluminum.

In some embodiments, the inner housing structure has a circular cross-sectional shape.

In some embodiments, the thermal energy assembly includes a screen member and a support rack.

In some embodiments, the screen member is configured to filter the particulate material with a size of at least 180 microns.

In some embodiments, the screen member is produced from a woven nickel alloy wire.

In some embodiments, the thermal energy assembly is removable disposed within a chamber of the housing assembly.

In some embodiments, the at least one cooking zone generates a temperate of at least 1100° F.

In some embodiments, the at least one cooking zone utilizes convection thermal energy transfer and radiant thermal energy transfer.

In yet another embodiment, a cooking system, comprises: a housing assembly having a plurality of cooking zones and a plurality of fluid flow paths; and at least one thermal energy source in fluid communication with the fluid flow paths to provide a heated fluid to at least one of the cooking zones.

In some embodiments, the cooking system further comprises a blower assembly in fluid communication with at least one fluid flow path.

In some embodiments, the blower assembly is configured to force a fluid through the at least one fluid flow path and the at least one thermal energy source to at least one of the cooking zones.

In some embodiments, the fluid is superheated to a temperature of at least about 800° F.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front perspective view of a cooking system according to an embodiment of the present disclosure, wherein an additional cooking device is shown therewith;

FIG. 2 is a rear perspective view of the cooking system of FIG. 1;

FIG. 3 is an exploded front perspective view of the cooking system of FIGS. 1 and 2;

FIG. 4 is a front perspective view of an embodiment of an inner housing structure of the cooking device of FIGS. 1-3;

FIG. 5 is a cross-sectional view of the cooking system of FIGS. 1-3;

FIG. 6 is an exploded perspective view of an embodiment of a thermal energy source and a thermal energy assembly for the cooking system of FIGS. 1-3 and 5

FIG. 7 is a cross-sectional view of the cooking system of FIGS. 1-3 and 5, wherein a plurality of cooking zones and a thermal energy zone are shown;

FIG. 8 is a schematic cross-sectional view of the cooking system of FIGS. 1-3 and 5, wherein a broiling or searing mode is shown;

FIG. 9 is a schematic cross-sectional view of the cooking system of FIGS. 1-3 and 5, wherein a grilling mode is shown;

FIG. 10 is a schematic cross-sectional view of the cooking system of FIGS. 1-3 and 5, wherein a warming mode is shown; and

FIGS. 11 and 12 are perspective views of the cooking system of FIGS. 1-3 and 5, wherein the cooking system includes optional accessories.

### DETAILED DESCRIPTION

The following description of technology is merely exemplary in nature of the subject matter, manufacture and use of one or more presently disclosed subject matters, and is not intended to limit the scope, application, or uses of any specific presently disclosed subject matter claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

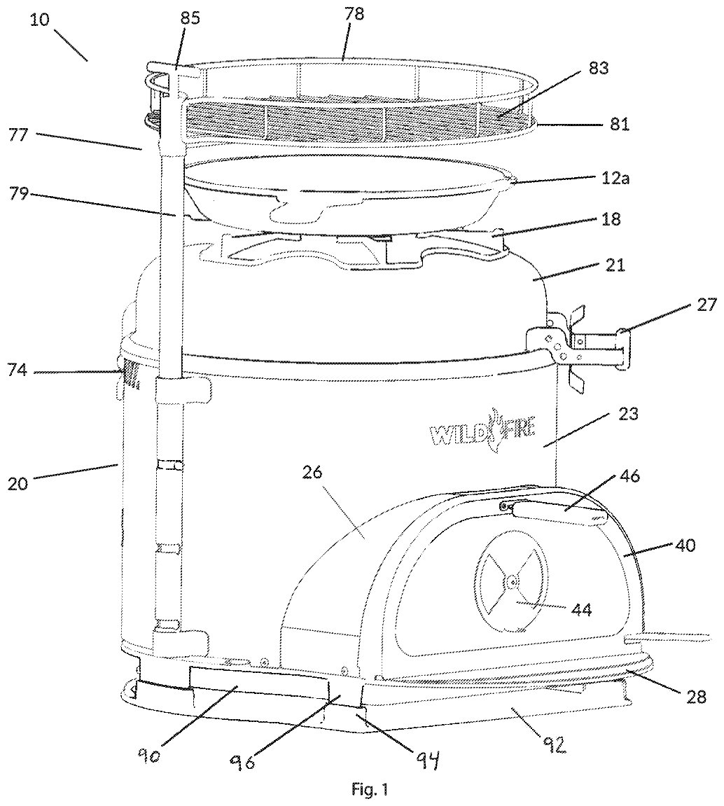

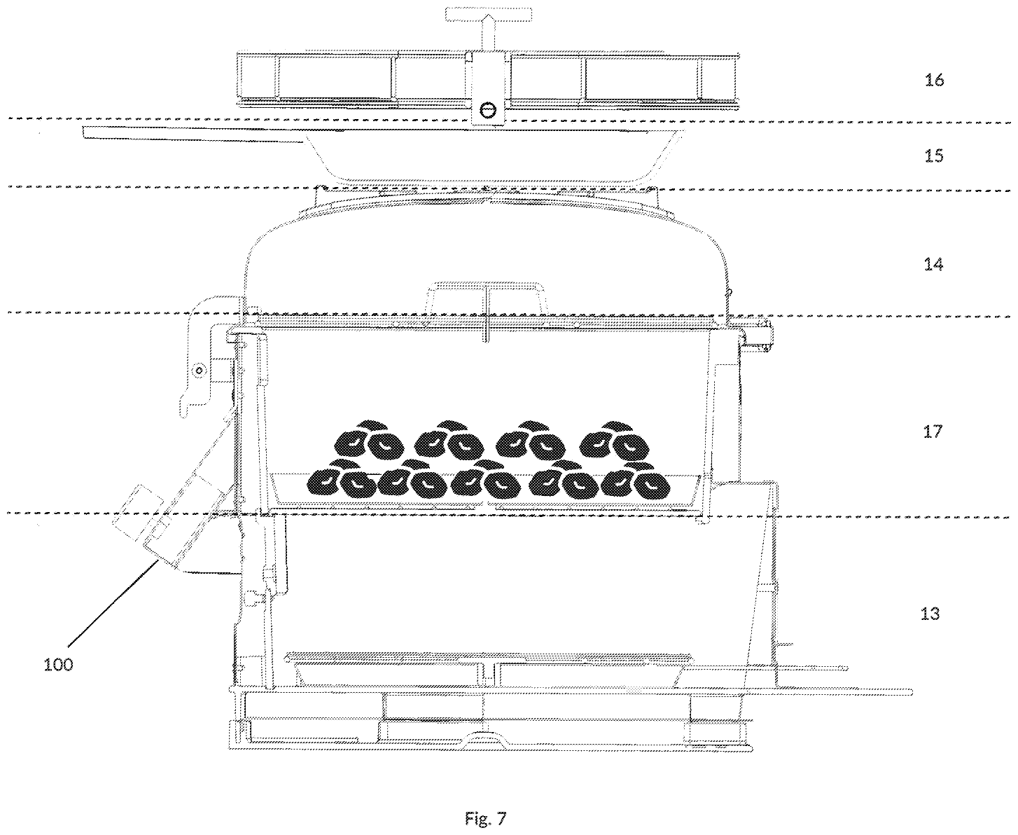

FIGS. 1-3 illustrate a cooking system 10 in accordance with an embodiment of the present disclosure. The cooking system 10 may be provided with additional cooking devices 12 (e.g. a frying pan, an iron skillet 12a, etc.), as desired. The cooking system 10 shown may be an outdoor broiling, cooking, and grilling device that has a plurality of distinct cooking zones, which a user may employ substantially simultaneously or individually during food preparation. More preferably, the cooking system 10, as shown in FIG. 7, may be configured to provide four distinct cooking zones 13, 14, 15, 16 and a thermal energy zone 17 disposed between two of the cooking zones 13, 14, 15, 16. In some embodiments, the cooking zones 13, 14, 15, 16 may be a broiler-oven zone, a traditional grill zone, a warming center zone, and an elevated and adjustable grill zone, respectively. The cooking zones 13, 14, 15, 16 are heated by the thermal energy zone 17 that is centrally located within a vertically stacked configuration. It is understood that the cooking system 10 may be suitable for other cooking applications as desired.

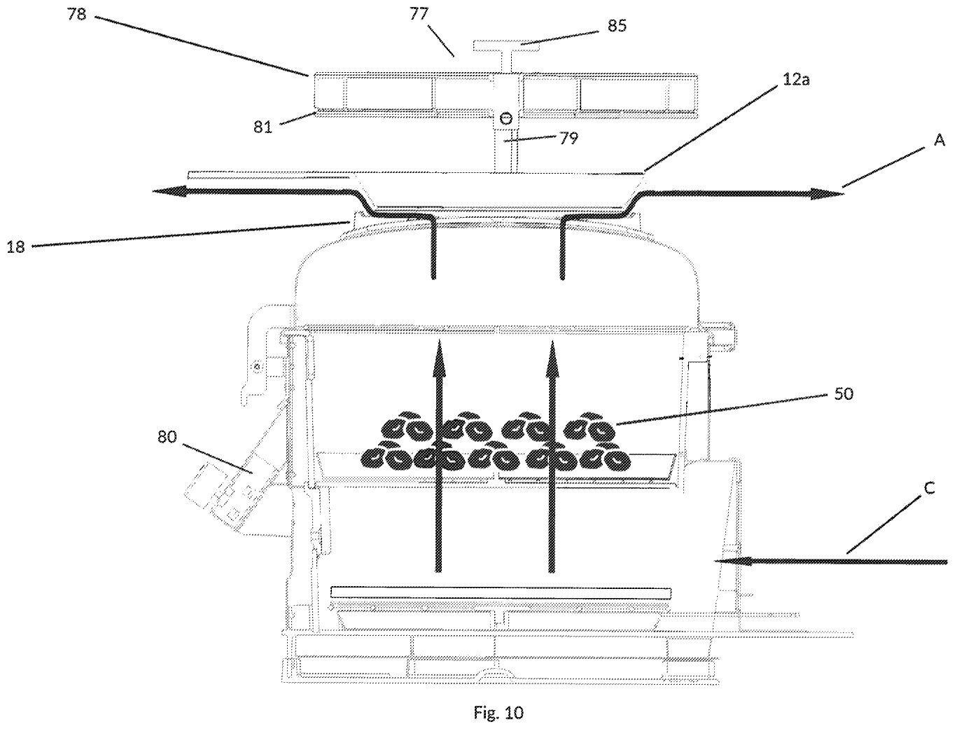

In some embodiments, the cooking system 10 may include a housing assembly 20 provided with a lid 21. In certain embodiments, the lid 21 may include one or more openings 19 and an associated damper 18 to selectively permit and control a flow of a heated fluid (e.g. heated air) from the cooking zone 14 along a fluid flow path indicated by arrow “A” shown in FIG. 10. A handle 27 may be provided on the closure member 40 to assist the user with a positioning, opening, and closing of the lid 21. Although the lid 21 shown is coupled to the housing assembly 20 by a hinged connection, it is understood that the lid 21 may be movably and/or removably coupled to the housing assembly 20 by any method as desired. It is also understood that the lid 21 may be unconnected and freely disposed on the housing assembly 20, if desired. In some embodiments, the lid 21 and/or the damper 18 may be configured to receive one of the cooking devices 12 thereon to provide the cooking zone 15 shown in FIG. 7.

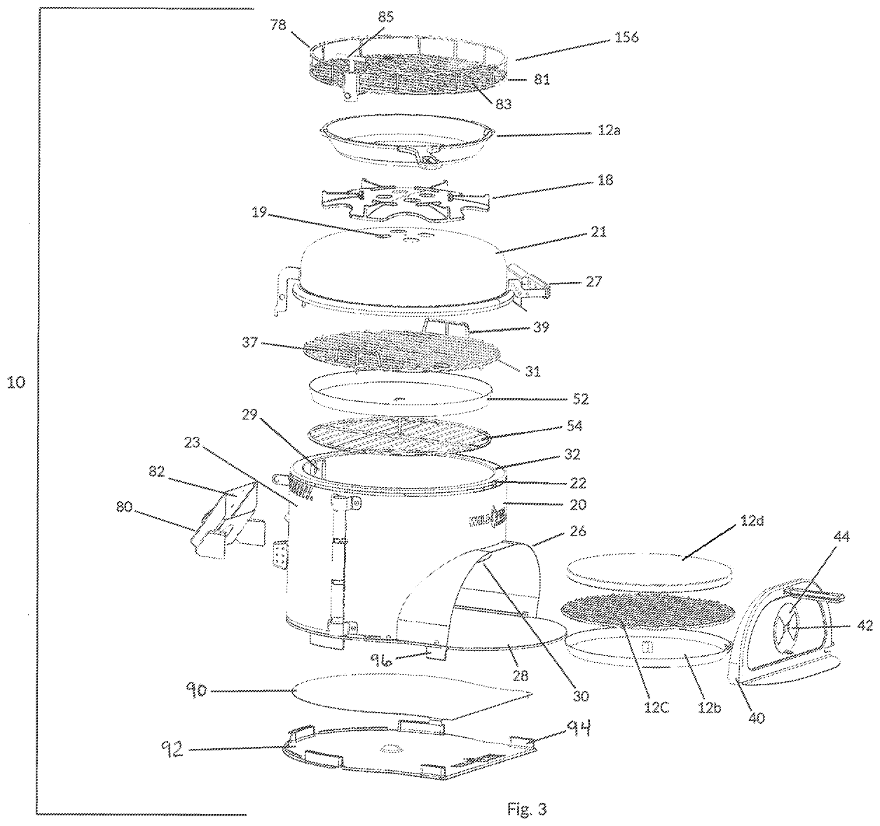

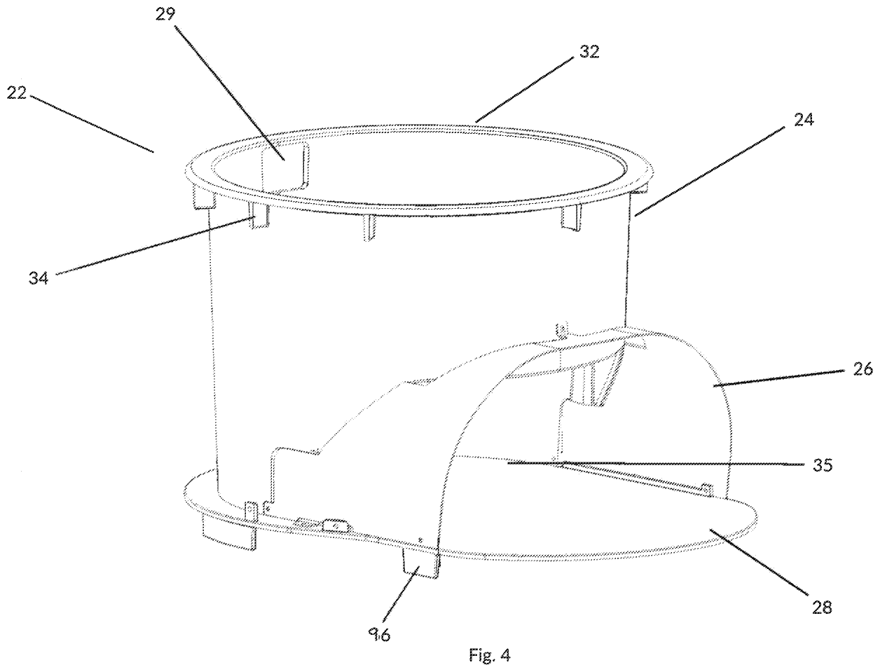

As best seen in FIG. 3, the housing assembly 20 may comprise an inner housing structure 22 and an outer housing structure 23 formed to surround the inner housing structure 22. In one embodiment shown in FIG. 4, the inner housing structure 22 may include a generally cylindrical body portion 24 defining a chamber 25 therein, an inlet/outlet portion 26 coupled to the body portion 24, and a base portion 28 coupled to the body portion 24 and the inlet/outlet portion 26. It is understood that the body portion 24 may be formed from a cast aluminum material, if desired. It should be appreciated that the housing structures 22, 23 may be produced from any combination of ferrous or nonferrous alloys; however, aluminum may be used primarily for its lightweight properties and ability to transfer heat quickly away from the cooking system 10 while in operation. Important to overall performance, the cooking system 10, and more particularly the inner housing structure 22, may have a generally circular cross-sectional shape, which creates optimal fluid conditions of balance and flow. Such shape is essential in allowing superheated fluid flows to perform cooking tasks quickly and efficiently and then exiting the cooking system 10 immediately to militate against premature corrosion and damage caused by excess heat conditions resulting from trapped superheated fluid flow.

It should also be appreciated that the body portion 24, the inlet/outlet portion 26, and the base portion 28 may be coupled together by any suitable method as desired such as by mechanical fasteners, a welding process, and the like, for example.

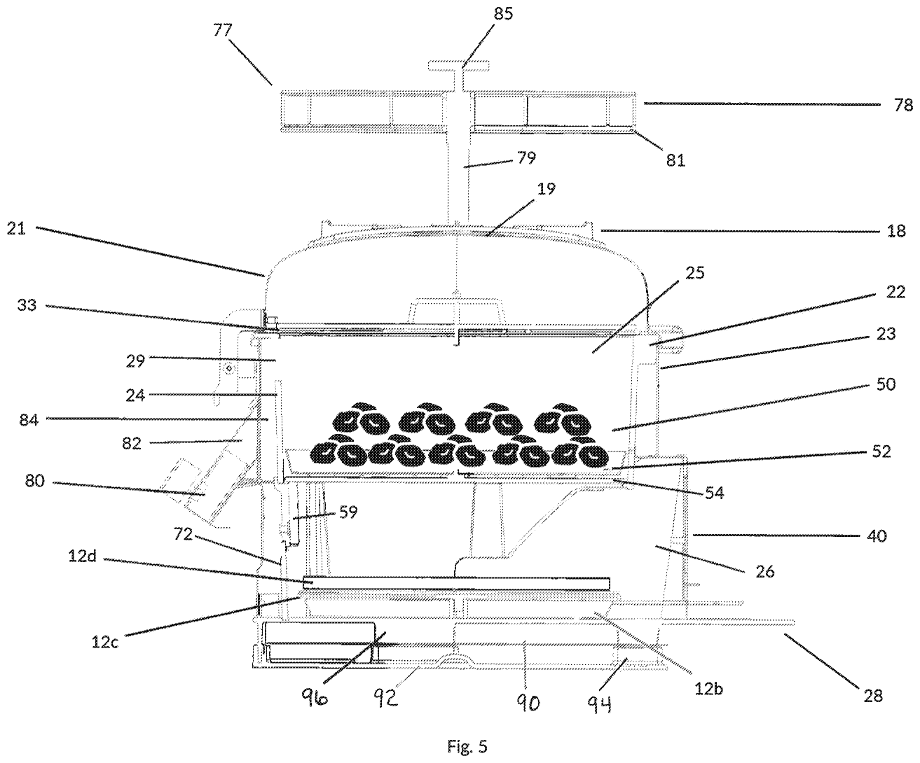

The body portion 24 may include an aperture 29 formed therein and a rim 32 extending radially outwardly from an upper portion thereof. As shown in FIG. 4, the rim 32 may be supported by an array of spaced apart ribs 34 extending radially outwardly from the outer circumferential surface of the body portion 24. As shown in FIG. 5, a support rack 33 may be disposed on and supported by the rim 32. In a non-limiting example, the support rack 33 may include a ring member 31 with a plurality of spaced-apart cross-members 37 extending across a diameter thereof. It is understood that any number of cross-members 37 may be disposed on the ring member 60 in any configuration as desired to permit a flow of the heated fluid from the thermal energy zone 17 to the cooking zone 14. It is further understood that the support rack 33 may be formed from any suitable heat-resistant and/or heat-tolerant material as desired. In certain embodiments, the support rack 33 may also be configured to be removable from the housing assembly 20 to allow the thermal energy source 50 to be removed and/or replaced and the support rack 33 and other components within the housing assembly 20 to be cleaned. At least one handle 39 may extend upwardly from the support rack 33 may be employed to facilitate such removal from the housing assembly 20.

The body portion 24 may further include a relatively large opening 30 formed in a front, lower portion thereof. The opening 30 may be surrounded by the inlet/outlet portion 26, which has a generally arcuate cross-sectional shape and may be configured to cooperate with at least a part of the opening 30 and an outer surface of the body portion 24. The inlet/outlet portion 26 may define a passageway 35 between the chamber 25 of the housing assembly 20 and the atmosphere. As depicted, the base portion 28 maybe generally planar to further define the chamber 25 of the housing assembly 20 and the passageway 35 of the inlet/outlet portion 26.

Now turning to FIGS. 3 and 5, the chamber 25 of the housing assembly 20 and the passageway 35 of the inlet/outlet portion 26 may be configured to receive one or more of the cooking devices 12 therein. In a non-limiting example, a lower portion of the chamber 25 of the housing assembly 20, which forms the cooking zone 13 shown in FIG. 7, and the passageway 35 of the inlet/outlet portion 26 may be of a suitable size and shape to receive at least one of a collection pan 12b, a grill member 12c, and at least one piece of stoneware 12d (e.g. a pizza stone). It should be appreciated that the grill member 12c may be rotatably disposed on or rotatably coupled to the collection pan 12b and/or the base portion 28 to facilitate even cooking and permit the user to easily place and remove food therefrom. It is also understood that the grill member 12c may be sized and shaped to receive and support the piece of stoneware 12d thereon.

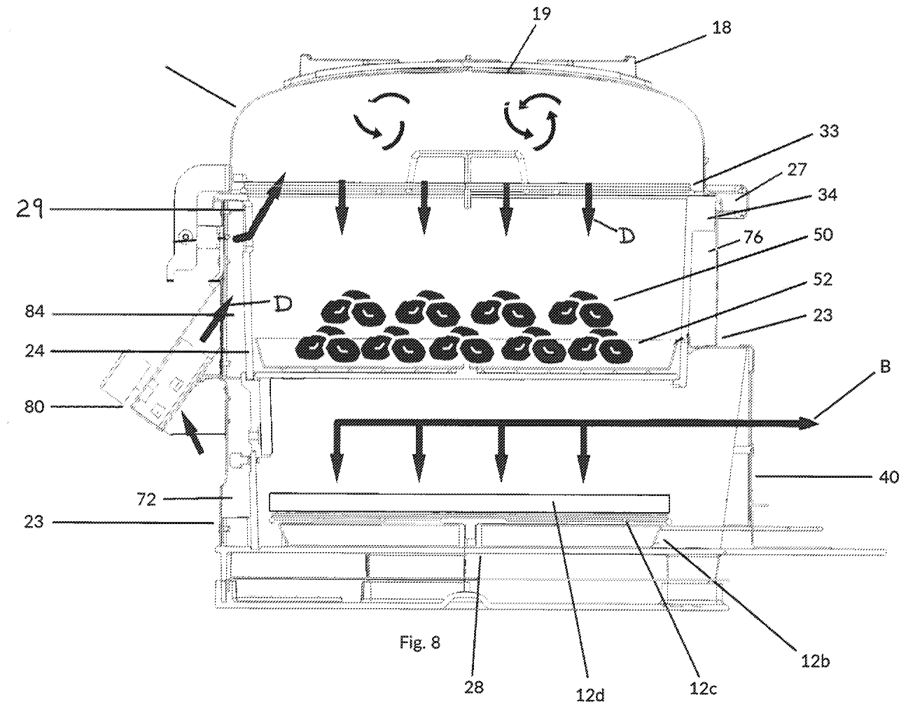

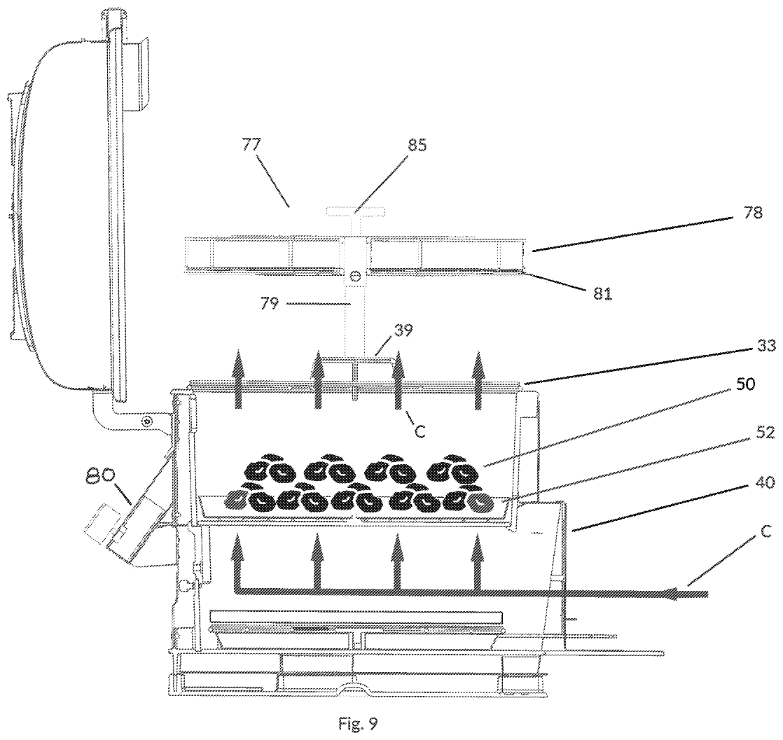

Referring back to FIGS. 1-3, the housing assembly 20 may further include a closure member 40 configured to be at least partially disposed in the passageway 35 to militate against access to the chamber 25 and a flow of fluid therethrough and into the cooking zone 13. It is understood, however, that in some embodiments the closure member 40 may include an opening 42 and an associated damper 44 to selectively permit and control a flow of the heated fluid from the cooking zone 13 along a fluid flow path indicated by arrow “B” in FIG. 8 and a flow of the fluid from the atmosphere through the passageway 35 of the inlet/outlet portion 26 and into the chamber 25 along a fluid flow path indicated by arrow “C” shown in FIGS. 9 and 10. A handle 46, shown in FIG. 1, may be provided on the closure member 40 to assist the user with a positioning, an insertion, and/or a removal of the closure member 40 in the inlet/outlet portion 26.

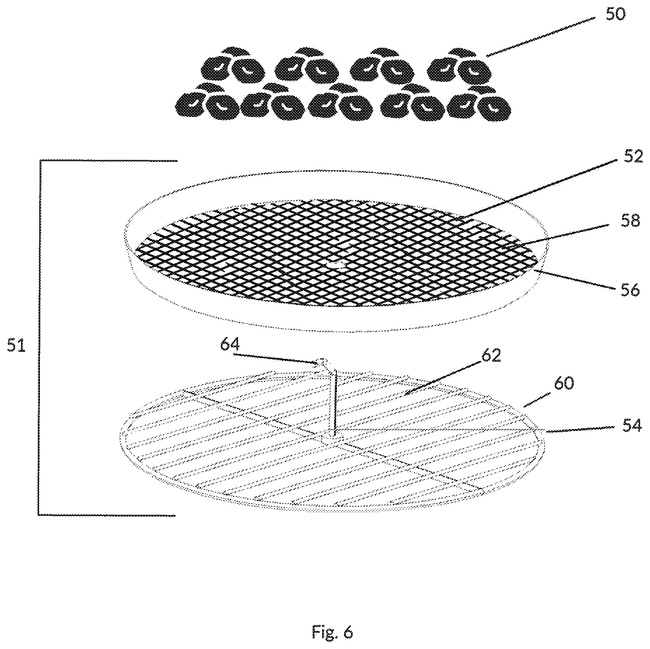

As best seen in FIGS. 5-7, the thermal energy zone 17 may be located in an upper portion of the chamber 25 of the housing assembly 20. In certain embodiments, the thermal energy zone 17 may be provided with at least one thermal energy source 50 disposed in a thermal energy assembly 51. As more clearly shown in FIG. 6, the thermal energy assembly 51 may comprise a screen member 52 and a support rack 54. Although the thermal energy source 50 shown is a solid source, it is understood that the thermal energy source 50 may be any suitable type of thermal energy producer as desired. As a non-limiting example, the thermal energy source 50 may be charcoal, briquettes or lump, and/or wood chips for flavor, if desired. The properties of charcoal are advantageous for the cooking system 10 because charcoal produces temperatures in excess of 2300° F. when the fluid is caused to flow therethrough. As illustrated, the thermal energy source 50 may be disposed in the screen member 52 whose position is maintained by the support rack 54. The screen member 52 is configured to cause back pressure to the flow of fluid therethrough during the operation of the cooking system 10, which in turn, balances the flow of the fluid through the thermal energy source 50 and into the cooking zone 13. In preferred embodiments, the screen member 52 may be configured to contain the thermal energy source 50 and permit the flow of the fluid therethrough during an operation of the cooking system 10, while militating against contaminants and particulates (e.g. charcoal dust) from entering the cooking zone 13 located beneath the thermal energy zone 17. For example, the screen member 52 may include an upstanding rim 56 and a bottom 58 constructed of woven nickel alloy wire capable of filtering contaminants and/or particulates having a size of at least 180 microns. It is understood, however, that the screen member 52 may be formed from any suitable material with the aforementioned characteristics as desired.

In some embodiments, the support rack 54 may be configured to maintain a position of the screen member 52 and permit the flow of the fluid therethrough during the operation of the cooking system 10. As shown in FIG. 5, the support rack 54 may be disposed on and supported by a plurality of ribs 59 that extend radially inward from an inner circumferential surface of the body portion 24 into the chamber 25. In a non-limiting example, the support rack 54 may include a ring member 60 with a plurality of spaced-apart cross-members 62 extending across a diameter thereof. As shown in FIG. 6, one or more of the cross-members 62 may extend across the diameter of the ring member 60 in a first direction and one or more of the cross-members 62 may extend across the diameter of the ring member 60 in a perpendicular second direction. It is understood that any number of cross-members 62 may be disposed on the ring member 60 in any configuration as desired. It is further understood that the support rack 54 may be formed from any suitable heat-resistant and/or heat-tolerant material as desired. In certain embodiments, the screen member 52 and/or the support rack 54 may also be configured to be removable from the chamber 25 to allow the thermal energy source 50 to be removed and/or replaced and the screen member 52 to be cleaned. A handle 64 extending upwardly from the support rack 54 may be employed to facilitate such removal from the housing assembly 20.

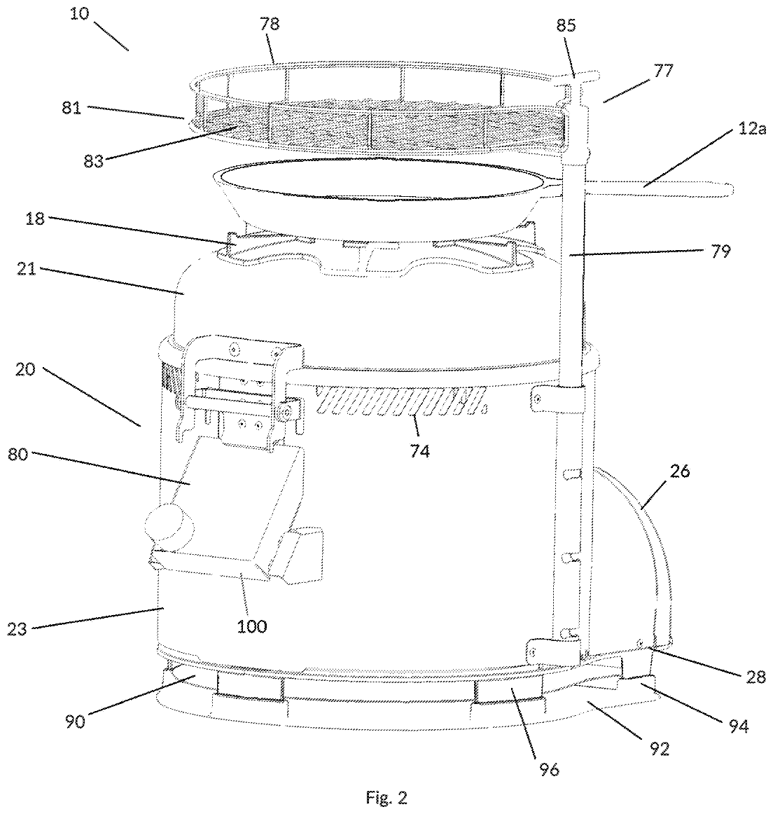

Referring back to FIGS. 1-3 and 5, the outer housing structure 23 has a generally circular cross-sectional shape and may further include a relatively large opening 70 formed in a front, lower portion thereof to accommodate the inlet/outlet portion 26 of the inner housing structure 22. A space 72 may be formed between the outer housing structure 23 and the inner housing structure 22 to permit a flow of the fluid from the atmosphere to flow around and provide cooling to the outer housing structure 23. The fluid in the space 72 may be permitted to exit the space 72 via one or more openings 74, shown in FIG. 2, formed in the outer housing structure 23. Preferably, a distance between the housing structures 22, 23 is about 1 inch. However, it is understood that the distance may be more or less if desired. In some embodiments, an additional space 76 may be formed between the outer housing structure 23 and the inlet/outlet portion 26 to perform as a vent and militate against a heated fluid from flowing into a face and body of the user.

In preferred embodiments, the cooking system 10 may further include an adjustable support rack assembly 77. As shown, the support rack assembly 77 may comprise a support rack 78 rotatably coupled to an adjustable arm member 79. In comes embodiments, the support rack 78 may be configured to be selectively positionable between 0 and 360 degrees about the arm member 79. As such, the support rack 78 may be vertically aligned with, slightly offset, or completely removed away from the thermal energy zone 17. Additionally, the arm member 79 may be configured to be selectively positionable between a first vertical position within the cooking zone 14 adjacent the support rack 33 and a second vertical position within the cooking zone 16 above the lid 21 and the cooking zone 15. It is understood that the arm member 79 may be movably coupled to the housing assembly 20 by any suitable method as desired. As shown in FIGS. 1-3 and 5, the support rack 78 may include a ring member 81 with a plurality of spaced-apart cross-members 83 extending across a diameter thereof. It is understood that any number of cross-members 83 may be disposed on the ring member 81 in any configuration as desired to permit a flow of the heated fluid from the thermal energy zone 17 to surround the food being prepared. It is further understood that the support rack 78 may be formed from any suitable heat-resistant and/or heat-tolerant material as desired. In certain embodiments, the support rack 78 may also be configured to be removable from the housing assembly 20. At least one handle 85 may extend upwardly from the support rack 78 may be employed to facilitate positioning relative to the housing assembly 20 and removal therefrom.

A blower assembly 80 may also be removably or fixedly coupled to the housing assembly 20, and more particularly, the outer housing structure 23. The blower assembly 80 shown includes a passageway 82 to permit a flow of the fluid therethrough. The passageway 82 may be in fluid communication with the atmosphere and a plenum 84 formed between the housing structures 22, 23. As more clearly shown in FIG. 5, the plenum 84 may be in fluid communication with the thermal energy zone 17 via the aperture 29 formed in the body portion 24 of the inner housing structure 22. In some embodiments, the blower assembly 80 includes a blower (not depicted), for example a rotatable fan blade, configured to draw the fluid from the atmosphere and force the fluid to flow along a fluid flow path indicated by arrows D in FIG. 8 through the passageway 82, through the plenum 84, into an interior of the lid 21 where the fluid is mixed with the heated fluid from the thermal energy zone 17 and pressurized, through the thermal energy zone 17 wherein the mixed fluid is superheated, and into the cooking zone 13. The blower assembly 80 may be in electrical communication with a power source such as a battery, for example, to provide an electric current thereto. A rate of the flow of the fluid into the blower assembly 80 and through the fluid flow path indicted by arrows D may be selectively adjusted and controlled. In certain embodiments, the rate of flow of the fluid may be directly adjusted and controlled by the user via a control element 86 and/or wirelessly via an application accessible on an electronic device. In other embodiments, the cooking system 10 may further include a controller 100 configured to automatically adjust and control the rate of flow of the fluid through the fluid flow paths A, B, C, D of the cooking system 10. Preferably, the cooking system 10 may be configured to automatically control the rate of flow of the fluid through the fluid flow paths A, B, C, D of the cooking system 10 depending on parameters set by the user such as type and amount of food being prepared, which of the cooking zones 13, 14, 15, 16 being utilized, and the like, for example.

In certain embodiments, the housing assembly 20 may yet further include a deflector 90 and a heat-resistant and/or heat-tolerant base structure 92. The deflector 90 and the base structure 92 may be coupled to the inner housing structure 22 and/or the outer housing structure 23 by any suitable method as desired such as mechanical fasteners, a welding process, and the like, for example. As shown, the deflector 90 may be disposed between the base portion 28 and the base structure 92 of the housing assembly 20. The deflector 90 may have a generally planar shape and capable of deflecting thermal energy emitted from the chamber 25 back through the base portion 28 and away from a supporting structure (not depicted) such as a tabletop, for example. The base structure 92 may also be generally planar and include one or more receptacles 94 extending upwardly therefrom. Each of the receptacles 94 may be configured to receive a corresponding one of protuberances 96 extending downwardly from the base portion 28 therein. The base structure 92 may be formed from a material, for example silicone, that is capable of absorbing and/or slowing the flow of the thermal energy to militate against a transfer of the thermal energy to the supporting structure.

It is understood that any of the components of the cooking system 10 may be formed from any suitable material such as non-ferrous, high-temperature nickel alloys or ceramic materials, for example.

Operating the cooking zone 13 in a broiler-oven mode is shown in FIG. 8. During high-temperature operation the adjustable blower assembly 80, powered by battery or external power source, is operating and pushing fluid through the passageway 82 and the plenum 84, through the aperture 29, and into the cooking zone 14 with the lid 21 closed. The pressurized fluid flows downward through the thermal energy zone 17, where the fluid is superheated to about 800° F. to about 1200° F. The superheated fluid then flows from the thermal energy zone 17 into and through the cooking zone 13 for use in high-temperature searing or broiling in a balanced and continuous manner. As such, the cooking zone 13 utilizes convection thermal energy transfer and radiant thermal energy because of its location beneath the thermal energy zone 17.

Operating the cooking zone 14 in a traditional grill mode is shown in FIG. 9. With the lid 21 open and the blower assembly 80 turned off, the user can control fluid flow from below the thermal energy zone 17 with the manually operated closure member 40 and the damper 44. The operating characteristics in this mode of operation are typical to charcoal grill in terms of temperature and cooking capability which ranges from low temperature to high temperature.

Operating the cooking zone 16 in an elevated and adjustable grill mode is also shown in FIG. 9. With the lid 21 open and the blower assembly 80 turned off, the user can control air flow from below the thermal energy zone 17 with the manually operated closure member 40 and the damper 44. The operating characteristics in this mode of operation are the ability to grill using the cooking zone 14 while also grilling, cooking or warming food above that surface on the adjustable support rack assembly 77 in the cooking zone 16. The adjustable support rack assembly 77 can also be rotated out of the cooking zones 14, 16 to prevent further cooking and hold food temperature.

Operating the cooking zone 15 in a warming center mode is shown in FIG. 10. With the lid 21 closed, the user can put a cooking device 12 onto the damper 18. Rotating the damper 18 increases or decreases a volume of waste heat from the chamber 25, allowing for either warming or cooking of food in the cooking device 12.

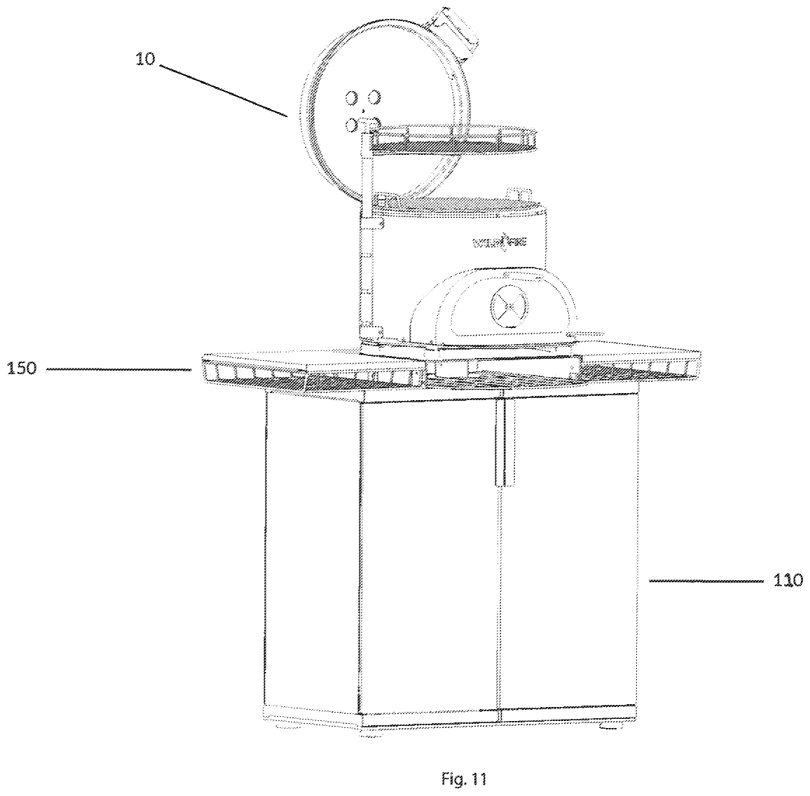

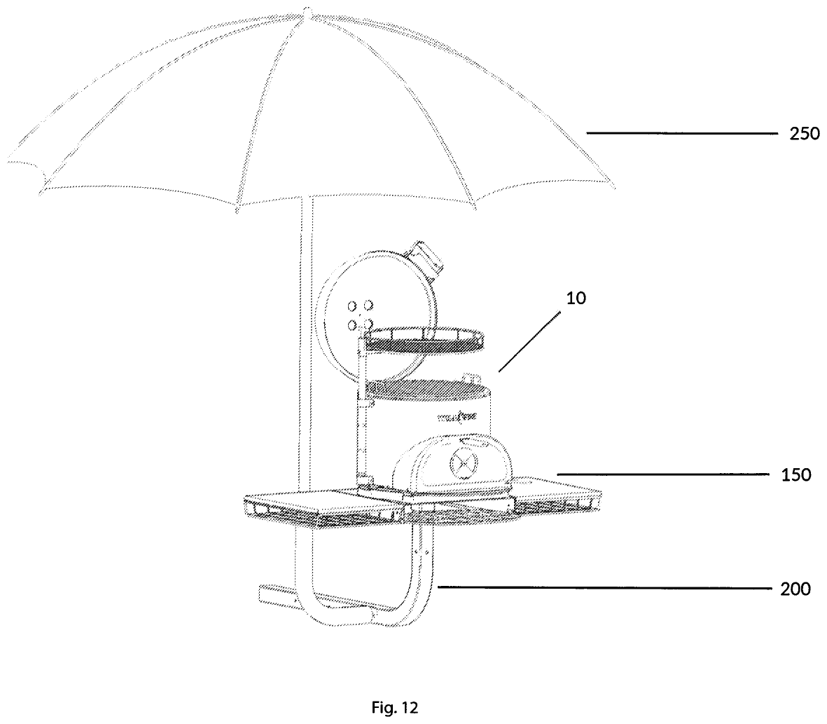

In other embodiments shown in FIGS. 11 and 12, the cooking system 10 may be configured for use with the following: (1) a ferrous or nonferrous metal stand 110 (shown in FIG. 11) that supports the cooking system 10 and acts storage for tools and accessories; (2) side mount work tables 150 (shown in FIGS. 11 and 12) which may be added to the cooking device 10 to hold unprepared and prepared foods as well as utensils; and/or (3) a metal framework 200 (shown in FIG. 12) which may be used to attach the cooking system 10 (and optionally an umbrella 250) to a trailer hitch to create a mobile outdoor cooking space.

The presently disclosed cooking system 10 is unique in that it is structurally different from other known devices. More specifically, the cooking system 10 is unique to the presence of: (1) the blower assembly 80 that pushes pressurized fluid through the thermal energy source 50 to create a sustained and stable source of superheated convection cooking fluid; (2) multiple cooking zones that places a highest-temperature cooking zone 13 below the thermal energy source 50, the traditional cooking zone 14 above the thermal energy source 50, and the warming center zone 16 located above the entire housing assembly 20 to harvest waste heat for warming and cooking; (3) an overall circular cross-sectional shape to mix and balance fluid flow, heat and cooking capability throughout the cooking system; (4) instantly switchable cooking zones 13, 14, 15, 16 through managing the blow assembly 80 and convection fluid flow through the cooking system 10; (5) the outer housing structure 23 that allows cool fluid to flow through the housing assembly 20 to facilitate a cooling thereof; and (6) the use of cast aluminum for the body portion 24 for heat dissipation.

The presently disclosed cooking system 10 is superior to other known methods and systems because: (1) a user can broil and sear foods at 800° F.-1200° F. while also traditionally grilling and warming food in one device; (2) a user can switch quickly between cooking zones 13, 14, 15, 16 within the cooking system 10 to prepare a wide range of foods and varying temperatures in one device at the substantially simultaneously or individually.

As to a further discussion of the manner of usage and operation of the presently disclosed subject matter, the same should be apparent from the above description. Accordingly, no further discussion relating to the manner of usage and operation will be provided. With respect to the above description, it is to be realized that the optimum dimensional relationships for the parts of the presently disclosed subject matter, to include variations in size, materials, shape, form, function and manner of operation, assembly and use, are deemed readily apparent and obvious to one skilled in the art, and all equivalent relationships to those illustrated in the drawings and described in the specification are intended to be encompassed by the presently disclosed subject matter. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A cooking system, comprising:
a housing assembly having a plurality of cooking zones and at least one thermal energy zone provided therein, wherein the at least one thermal energy zone is located between a pair of the cooking zones.

2. The cooking system of claim 1, wherein the cooking zones generate temperatures in range of about 200° F. to about 1200° F.

3. The cooking system of claim 1, wherein at least one of the cooking zones generates a temperate of at least 1100° F.

4. The cooking system of claim 1, wherein at least one of cooking zones of the cooking system utilizes convection thermal energy transfer and radiant thermal energy transfer.

5. The cooking system of claim 1, wherein the at least one thermal energy zone is provided with a thermal energy source and a thermal energy assembly configured to contain the thermal energy source therein.

6. The cooking system of claim 1, wherein the housing assembly provides four cooking zones.

7. A cooking system, comprising:
a housing assembly having at least one cooking zone; and
a thermal energy assembly disposed within the housing assembly, wherein the thermal energy assembly is configured to permit a flow of a fluid therethrough while militating against particulate material entering the at least one cooking zone.

8. The cooking system of claim 7, wherein the housing assembly includes an inner housing structure and an outer housing structure.

9. The cooking system of claim 8, wherein at least a portion of the inner housing structure is formed from a cast aluminum.

10. The cooking system of claim 8, wherein the inner housing structure has a circular cross-sectional shape.

11. The cooking system of claim 7, wherein the thermal energy assembly includes a screen member and a support rack.

12. The cooking system of claim 11, wherein the screen member is configured to filter the particulate material with a size of at least 180 microns.

13. The cooking system of claim 11, wherein the screen member is produced from a woven nickel alloy wire.

14. The cooking system of claim 7, wherein the thermal energy assembly is removable disposed within a chamber of the housing assembly.

15. The cooking system of claim 7, wherein the at least one cooking zone generates a temperate of at least 1100° F.

16. The cooking system of claim 7, wherein the at least one cooking zone utilizes convection thermal energy transfer and radiant thermal energy transfer.

17. A cooking system, comprising:
a housing assembly having a plurality of cooking zones and a plurality of fluid flow paths; and
at least one thermal energy source in fluid communication with the fluid flow paths to provide a heated fluid to at least one of the cooking zones.

18. The cooking system of claim 17, further comprising a blower assembly in fluid communication with at least one fluid flow path.

19. The cooking system of claim 18, wherein the blower assembly is configured to force a fluid through the at least one fluid flow path and the at least one thermal energy source to at least one of the cooking zones.

20. The cooking system of claim 19, wherein the fluid is superheated to a temperature of at least about 800° F.
